(19) United States
(12) Patent Application Publication
(10) Pub. No.: US 2015/0104219 A1
(43) Pub. Date: Apr. 16, 2015

(54) DEVELOPING APPARATUS AND IMAGE FORMING APPARATUS

(71) Applicants: Kabushiki Kaisha Toshiba, Tokyo (JP); Toshiba Tec Kabushiki Kaisha, Tokyo (JP)

(72) Inventor: Daisuke YAMASHITA, Shizuoka-ken (JP)

(73) Assignees: Toshiba Tec Kabushiki Kaisha, Tokyo (JP); Kabushiki Kaisha Toshiba, Tokyo (JP)

(21) Appl. No.: 14/055,701

(22) Filed: Oct. 16, 2013

(51) Int. Cl. G03G 15/09

(52) U.S. Cl. CPC G03G 15/0812
USPC 399/272; 399/274

(57) ABSTRACT

A developing apparatus includes a developing unit configured to transfer a developer to an image carrying unit on which an electrostatic image is formed, a supplying unit configured to supply the developer to the developing unit, a regulating unit configured to regulate a thickness of the developer on the developing unit, and a repelling unit disposed between the supplying unit and the regulating unit and configured to repel the developer.

### FIELD

Embodiments described herein relate to a developing apparatus.

### BACKGROUND

A developing apparatus used in a copier or a printer may be of a magnetic brush type, in which a doctor blade regulates a thickness of a developer formed on a developing roller. However, in such a magnetic brush type developing apparatus, the developer may remain and coagulate near the doctor blade. This coagulated developer may migrate onto the developing roller during a long-term use of the developing apparatus. Because of unevenness of the developer on the developing roller caused by the coagulating developer, quality of image may be impaired.

### BRIEF DESCRIPTION OF THE DRAWINGS

FIG. 1 is a schematic configuration diagram illustrating an image forming apparatus according to an embodiment.

FIG. 2 is a schematic configuration diagram illustrating an image forming station including a developing apparatus according to the embodiment.

### DETAILED DESCRIPTION

In accordance with the embodiment, a developing apparatus includes a developing unit configured to transfer a developer to an image carrying unit on which an electrostatic image is formed, a supplying unit configured to supply the developer to the developing unit, a regulating unit configured to regulate a thickness of the developer on the developing unit, and a repelling unit disposed between the supplying unit and the regulating unit and configured to repel the developer.

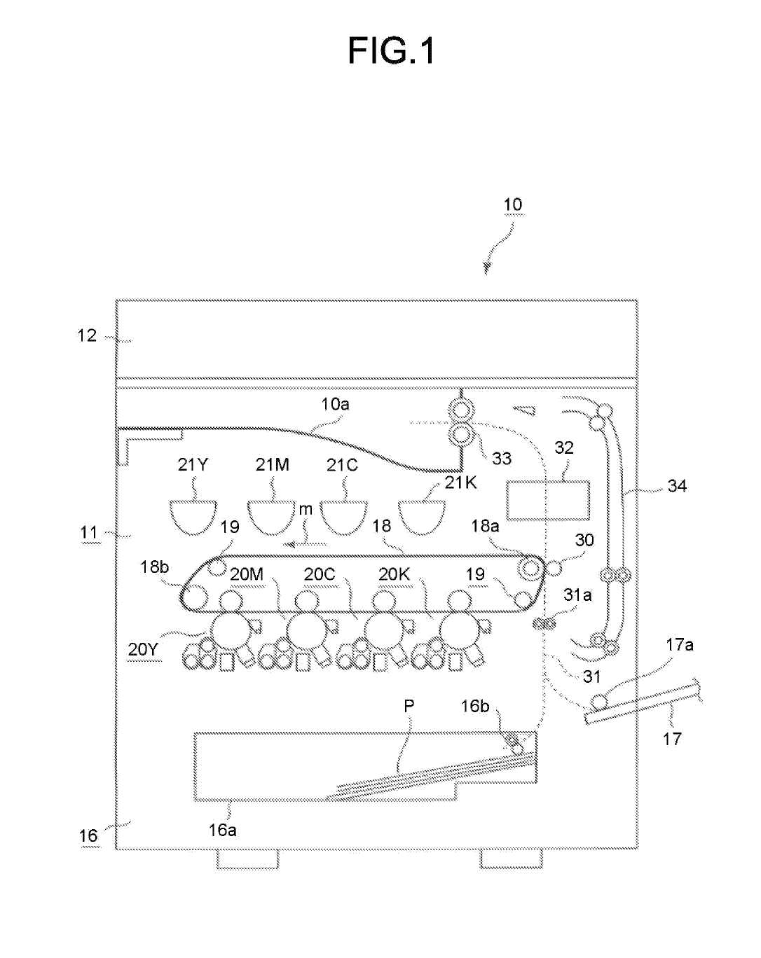

Embodiments are described below. FIG. 1 illustrates a color MFP (Multi-Function Peripheral) 10 serving as an example of an image forming apparatus according to the embodiment. The MFP 10 comprises a printer section 11, a scanner section 12, and a paper feed cassette section 16.

The paper feed cassette section 16 includes a paper feed cassette 16a for storing sheets P and a pickup roller 16b for feeding a sheet P from the paper feed cassette 16a. Either an unused sheet or a sheet for reuse (e.g. a sheet the image on which is erased through a color erasing processing) can be stored in the paper feed cassette 16a. The MFP 10 includes a manual feed tray 17 from which a pickup roller 17a feeds a sheet.

The printer section 11 comprises image forming stations 20Y, 20M, 20C, and 20K for colors of Y(yellow), M(magenta),C(cyan) and K(black), respectively, and the image forming stations 20Y, 20M, 20C, and 20K are arranged in parallel below an intermediate transfer belt 18 rotating in a direction along an arrow m. The printer section 11 further comprises replenishing cartridges 21Y, 21M, 21C, and 21K, which are disposed above the four image forming stations 20Y, 20M, 20C, and 20K, respectively.

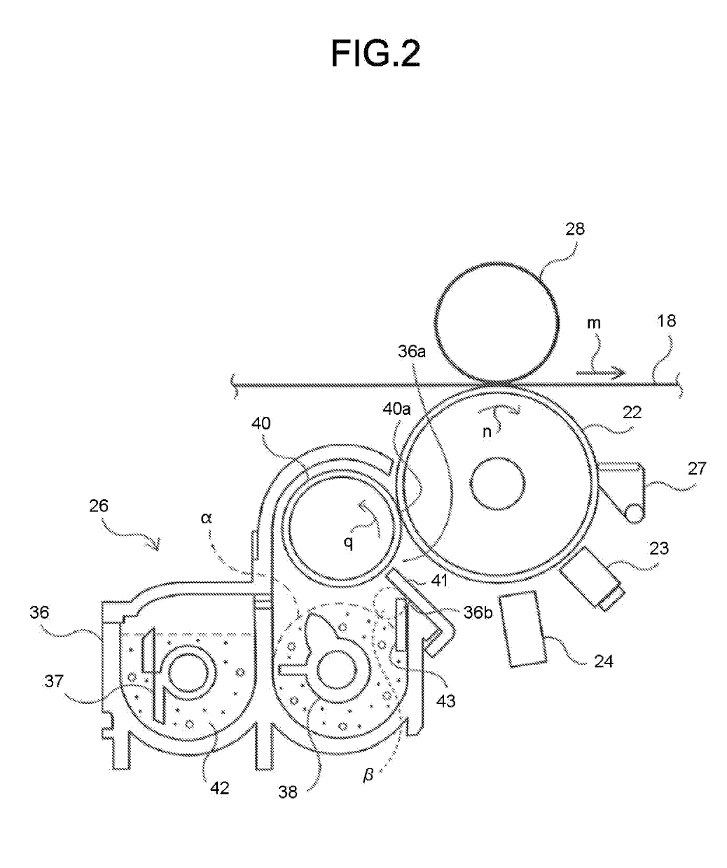

The image forming stations 20Y, 20M, 20C, and 20K are described below in detail. As structured identically, the image forming stations 20Y, 20M, 20C, and 20K are described with reference to FIG. 2 using the common numerals. Each of the image forming stations 20Y, 20M, 20C, and 20K includes an electrostatic charger 23, an exposure scanning head 24, a developing apparatus 26, and a photoconductor cleaner 27, each of which is disposed around a photoconductive drum 22 which serves as an image carrier and rotates in a direction along an arrow n.

In each of the image forming stations 20Y, 20M, 20C, and 20K, the exposure scanning head 24 exposes the photoconductive drum 22 electrified uniformly with the charged charger 23, so as to form an electrostatic latent image on the photoconductive drum 22. The developing apparatus 26 feeds a toner serving as a developer to the photoconductive drum 22 to visualize the electrostatic latent image. The electrostatic charger 23 and the exposure scanning head 24 constitute a latent image forming section.

Each of the image forming stations 20Y, 20M, 20C, and 20K is provided with a primary transfer roller 28 opposite to the photoconductive drum 22 with the intermediate transfer belt 18 disposed inbetween. The intermediate transfer belt 18 is conveyed in a direction along an arrow m by a backup roller 18a, a driven roller 18b, and a tension roller 19. The primary transfer roller 28 primarily transfers a toner image formed on the photoconductive drum 22 to the intermediate transfer belt 18. The primary transfer rollers 28 of the image forming stations 20Y, 20M, 20C, and 20K form a color toner image by superimposing the toner images of Y(yellow), M(magenta), C(cyan), and K (black) in sequence on the intermediate transfer belt 18. The photoconductor cleaner 27 removes the toner remaining on the photoconductive drum 22 after the primary transfer.

A secondary transfer roller 30 is located opposite to the backup roller 18a with the intermediate transfer belt 18 disposed inbetween and is driven by the intermediate transfer belt 18. The secondary transfer roller 30 secondarily transfers the color toner image on the intermediate transfer belt 18 to a sheet P fed from the paper feed cassette 16a or the manual paper tray 17 along a conveyance path 31.

Each of the replenishing cartridges 21Y, 21M, 21C, and 21K replenishes the toner to the developing apparatus 26 in accordance with consumption of the toner in the corresponding developing apparatus 26.

The printer section 11 includes resist rollers 31a along the conveyance path 31. The printer section 11 further includes a fixing device 32 and a paper discharging roller pair 33, each of which is disposed downstream with respect to the secondary transfer roller 30 along the conveyance path 31. The printer section 11 also includes a reversal conveyance section 34 downstream with respect to the fixing device 32.

With such a structure, the MFP 10 forms a color toner image on a sheet P at the printer section 11 and discharges the formed color toner image to a paper discharging section 10a. The image forming apparatus is not limited to the MFP 10. The image forming apparatus may also be a monochrome image forming apparatus, and no limitation is given to the number of the image forming stations. The image forming apparatus may transfer a toner image to a sheet directly from a photoconductor. Besides, the image forming apparatus may comprise a plurality of printer sections.

The developing apparatus 26 is described below in detail. As shown in FIG. 2, a case 36 of the developing apparatus 26 supports a stirring screw 37 and a feeding screw 38 serving as a supplying unit. The case 36 supports a developing roller 40 which rotates in a direction along an arrow q and functions as an image carrying unit. The developing roller 40 is partially exposed from an opening 36a of the case 36 and is opposite to the photoconductive drum 22. The case 36 supports a doctor blade 41 serving as a regulating unit and located at an end of the opening 36a below a position 40a where the developing roller 40 contacts the photoconductive drum 22.

A two-component developer 42 containing a toner and a magnetic carrier is stored in the case 36. The toner may be a non-erasable toner or erasable toner charged with negative polarity. The erasable toner is, for example, heated to decolorize the color of an image. The stirring screw 37 and the feeding screw 38 stir and convey the developer 42 and feed the developer 42 to the developing roller 40. The doctor blade 41 regulates a thickness of a developer layer formed in the magnetic brush shape around the developing roller 40 with the developer fed from the feeding screw 38.

An adhesive tape 43 serving as a repelling unit is disposed on an internal wall of the case 36 supporting the doctor blade 41. The adhesive tape 43 is made from Teflon (Product of DuPont Company), for example, and is stuck in the whole area in the longitudinal direction so that it is parallel to the doctor blade 41 on the internal wall of the case 36.

The adhesive tape 43 has a negative polarity the same as the charged polarity of the toner. The adhesive tape 43 is not limited to be made from Teflon, and can be made from any material having a triboelectrification series which is likely to have a negative polarity the same as the charged polarity of the toner. Further, when the charged polarity of the toner is positive, the material of the adhesive tape is selected to be a material having a triboelectrification series likely to have a positive polarity.

The repelling unit is not limited to the adhesive tape, and, as the repelling unit, a coagulation preventing sheet can be stuck on the internal wall of the case 36 with an adhesive. The use of an adhesive tape as the repelling unit makes it easy to stick to the case 36.

When a development is performed, an area of the developer 42 based on the feeding screw 38 is shown as a supply area α in FIG. 2. A gap β is formed outside the supply area α between the feeding screw 38 and the internal wall (the developer conveyance path) of the case 36. In such a structure, the developer 42 easily accumulates in the gap β.

The developer 42 scraped from the developer 40 by the doctor blade 41 also accumulates in the gap β. The toner will be coagulated if the accumulating developer 42 is heated and pressurized in the gap β, and the coagulated toner spreads out while the developing apparatus 26 is used for a long time.

The adhesive tape 43, which is triboelectrically charged with the same polarity as the toner of the developer 42, electrostatically repels the toner in the gap β to reduce the developer 42 accumulating in the gap β. The toner in the gap β is repelled towards the direction of the supply area α of the feeding screw 38, but is not attached on the internal wall surface of the case 36. The toner repelled by the adhesive tape 43 to the supply area α of the feeding screw 38 from the gap β circulates in the case 36. The adhesive tape 43 reduces the toner remaining in the gap β and reduces an amount of the toner coagulated on the internal wall surface of the case 36 while the developing apparatus 26 is used for a long time.

As the adhesive tape 43 reduces the amount of the tonner coagulated on the internal wall surface of the case 36, the adhesive tape 43 reduces an amount of the toner reaching an outside of the doctor blade 41 in the long-term use of the developing apparatus 26. The coagulated toner will not affect the napping of the developer on the developing roller even if the developing apparatus 26 is used for such a long time that the service life comes. The developing apparatus 26 can still obtain an excellent developed image free from an image defect until it reaches its service life.

As a comparative embodiment, no adhesive tape is stuck on the internal wall of the case 36, and a life test is carried out on the developing apparatus 26. In the comparative embodiment, a development defect appearing as an image void, such as a white streak or a white strip in a developed image, occurs before the developing apparatus 26 reaches service life. In the comparative embodiment, the coagulation of the toner in the developer 42 remaining in the gap β increases, and the coagulated toner reaches the outside of the doctor blade 41 before the developing apparatus 26 reaches its service life.

In the embodiment, the adhesive tape 43 triboelectrically charged with negative polarity is stuck on the internal wall of the case 36 at a side opposite to the side where the doctor blade 41 is attached. The adhesive tape 43 electrostatically repels the toner in the gap β having a negative polarity to reduce the toner remaining and coagulated on the internal wall of the case 36. Irrespective of the long-term use of the developing apparatus 26, the coagulated toner can be prevented from affecting the napping of the developer on the developing roller 40 according to the embodiment. In the embodiment, the developing apparatus 26 can still obtain an excellent developed image free of an image void until it reaches service life.

In the embodiment, the repelling unit can be any structure or made from any material as long as the repelling unit is capable of reducing the coagulation of the toner. The repelling unit may be a conductive sheet which is disposed on the internal wall of the case and charged with an electric field having the same polarity with the charged polarity of the toner during a period in which no development operation is carried out so as to reduce the remaining and coagulated toner.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

1. A developing apparatus, comprising:
a developing unit configured to transfer a toner to an image carrying unit on which an electrostatic image is formed;
a supplying unit configured to supply a developer including the toner and a carrier to the developing unit;
a regulating unit configured to regulate a thickness of the developer on the developing unit; and
a repelling unit disposed between the supplying unit and the regulating unit and configured to repel the toner.

2. The developing apparatus according to claim 1, wherein the repelling unit has a same polarity as a polarity of the toner.

3. The developing apparatus according to claim 2, wherein the toner and the repelling unit both have negative polarity.

4. The developing apparatus according to claim 2, wherein the repelling unit is charged with the polarity by friction.

5. The developing apparatus according to claim 1, wherein the repelling unit includes Teflon.

6. The developing apparatus according to claim 1, wherein the repelling unit includes a conductive material.

7. The developing apparatus according to claim 1, wherein the developing unit and the supplying unit are enclosed in a case, and the repelling unit is disposed on an inner wall of the case adjacent to the regulating unit.

8. The developing apparatus according to claim 1, wherein the toner on the developing unit of which thickness is regulated by the regulating unit is transferred from the developing unit to the image carrying unit.

9. An image forming apparatus, comprising:
an image forming unit including,
an image carrying unit on which an electrostatic image is formed,
a developing unit configured to transfer a toner to the image carrying unit,
a supplying unit configured to supply a developer including the toner and a carrier to the developing unit,
a regulating unit configured to regulate a thickness of the developer on the developing unit,
a repelling unit disposed between the supplying unit and the regulating unit and configured to repel the toner, and
a transfer unit configured to transfer a toner image on the image carrying unit to a sheet; and
a fixing unit configured to fix the toner image on the sheet.

10. The image forming apparatus according to claim 9, wherein the repelling unit has a same polarity as a polarity of the toner.

11. The image forming apparatus according to claim 10, wherein the toner and the repelling unit both have negative polarity.

12. The image forming apparatus according to claim 10, wherein the repelling unit is charged with the polarity by friction.

13. The image forming apparatus according to claim 9, wherein the repelling unit includes Teflon.

14. The image forming apparatus according to claim 9, wherein the repelling unit includes a conductive material.

15. The image forming apparatus according to claim 9, wherein the developing unit and the supplying unit are enclosed in a case, and the repelling unit is disposed on an inner wall of the case adjacent to the regulating unit.

16. The image forming apparatus according to claim 9, wherein the toner on the developing unit of which thickness is regulated by the regulating unit is transferred from the developing unit to the image carrying unit.

17. A method for developing a developer on a developing unit of an image forming apparatus, the method comprising:
supplying a developer including a toner and a carrier to the developing unit;
regulating a thickness of the developer on the developing unit with a regulating unit;
transferring the toner on the developing unit to an image carrying unit on which an electrostatic image is formed; and
causing a toner that is removed from the developing unit in accordance with the regulating, to be directed away from the regulating unit.

18. The method according to claim 17, wherein the toner is caused to be directed away from the regulating unit by a material disposed adjacent to the regulating unit.

19. The method according to claim 18, wherein the material has a same polarity as a polarity of the toner.

20. The method according to claim 19, wherein the toner and the repelling unit both have negative polarity.
